(19) United States
(12) Patent Application Publication
(10) Pub. No.: US 2005/0086685 A1
(43) Pub. Date: Apr. 21, 2005

(54) Method and system for providing emergency alert system messages in an internet protocol

(75) Inventors: Mashuqur Rahman, South Riding, VA (US); Aaron Harvey, Fairfax, VA (US)

Correspondence Address: MCGINN & GIBB, PLLC, 8321 OLD COURTHOUSE ROAD, SUITE 200, VIENNA, VA, 22182-3817, US

(73) Assignee: New Technology Management Inc., Reston, VA (US)

(21) Appl. No.: 10/968,040

(22) Filed: Oct. 20, 2004

Related U.S. Application Data
(60) Provisional application No. 60/512,088, filed on Oct. 20, 2003.

(51) Int. Cl. H04N 7/025

(52) U.S. Cl. 725/33; 340/531

(57) ABSTRACT

A method and system provides Emergency Alert System (EAS) messages in an Internet Protocol (IP) and broadcasts Emergency Alert System messages using an Internet Protocol.

The present Application is a Non-Provisional Application based upon U.S. Provisional Application No. 60/512,088, which was filed on Oct. 20, 2003.

### BACKGROUND OF THE INVENTION

1. Field of the Invention

The present invention relates to a method and system for providing Emergency Alert System (EAS) messages in an Internet Protocol (IP) and for broadcasting Emergency Alert System messages using an Internet Protocol.

2. Description of the Related Art

The Emergency Alert System may provide notice to the general public of emergencies and other hazardous events and also may provide instructions for responding to such emergencies and/or events. Emergency Alert System messages are conventionally generated by government agencies and relayed to the public by broadcasters and cable operators.

These Emergency Alert System messages are typically used to alert the public about different types of emergencies such as, for example, a weather emergency.

A conventional Emergency Alert System message is an audio message that is transmitted and relayed over amplitude modulated radio channels, frequency modulated radio channels, and television broadcasts.

An Emergency Alert System message conventionally includes a multipart audio message with audio data bursts. The conventional Emergency Alert System message contains three audio data bursts of header information, an eight second two-tone alert, a recorded verbal message and three audio data bursts that indicate the end of the message. The Emergency Alert System header and the end of message signal each conventionally include data that is encoded using the conventional process of Audio Frequency Shift Keying (AFSK).

The Emergency Alert System header conventionally contains the following information about the Emergency Alert System message: an origination code, an event type, the location of the event, the duration of the event, a timestamp, and a broadcast station identification.

Emergency Alert System messages are conventionally generated using hardware devices called Emergency Alert System encoders. Therefore, the conventional Emergency Alert System requires that each broadcaster/originator possess a specialized hardware encoder. These encoders encode the Emergency Alert System header information into audio data bursts using an Audio Frequency Shift Keying (AFSK) process. The specialized Emergency Alert System hardware encoders package the Emergency Alert System header along with a two-tone alert, a recorded verbal message and end of message audio bursts into a complete Emergency Alert System message for broadcast over an audio channel.

The audio Emergency Alert System messages are received and retransmitted by relay points which may include radio, television or cable operators who then, in turn, may broadcast the Emergency Alert System message to the public.

Conventional Emergency Alert System messages can only be decoded by those operators who possess a specialized hardware device called an Emergency Alert System decoder. The Emergency Alert System decoder allows an operator to decode the Emergency Alert System message.

The conventional Emergency Alert System network relies on multiple relay nodes. These relay nodes use widely varying technologies such as VHF and microwave links to relay the Emergency Alert System messages to other relay nodes.

### SUMMARY OF THE INVENTION

The conventional Emergency Alert System network requires that an Emergency Alert message originator possess a specialized piece of hardware known as an Emergency Alert System encoder. The Emergency Alert System encoder receives information from the originator and encodes that information into an audio file that is formatted in accordance with the Emergency Alert System Messaging protocol. The originator may then broadcast that encoded audio file across the airwaves.

Similarly, any party/entity which desires the ability to receive and decode a conventional Emergency Alert System message is required to possess a specialized piece of hardware known as an Emergency Alert System decoder. An Emergency Alert System decoder allows the receiver, who receives the Emergency Alert System Audio message from the airwaves, to decode the Emergency Alert System Audio message and, thereby, recover the information and present that information.

For example, an Emergency Alert System receiver that is a radio station who possesses the specialized Emergency Alert System decoder hardware is able to then present the information to that radio station's listeners. Similarly, a television station that possesses the specialized Emergency Alert System decoder hardware may then present the information contained in the Emergency Alert System message to its viewers, by for example, scrolling the information across the bottom of the television screen.

If an Emergency Alert System receiver, like a radio station or television station, wants to re-broadcast the Emergency Alert System message, then that radio station and/or television station must also possess the specialized Emergency Alert System encoder hardware.

In fact, the conventional Emergency Alert System relies upon these radio stations and/or television stations to possess such specialized hardware in order to ensure broad dissemination of the Emergency Alert System messages to the desired recipients.

However, one of the problems with the conventional Emergency Alert System is that not all of the radio stations and/or television stations possess the specialized hardware that is required to receive, decode and disseminate locally and to encode the messages for relaying across the airwaves to other stations.

Further, another problem with the conventional Emergency Alert System is that there are significant gaps in coverage. The inventors of the present invention realize that the coverage areas of the conventional Emergency Alert System network varies greatly from state to state, depending on the robustness of each state's relay networks. This dependence on relay nodes has led to gaps in coverage. Therefore, large portions of the public are not adequately served by the conventional Emergency Alert System.

Additionally, since the conventional Emergency Alert System requires that an Emergency Alert System message be relayed across multiple stations before the Emergency Alert System message can be adequately disseminated and/or delivered, there may be a significant delay before the Emergency Alert System message reaches all of the intended recipients.

In view of the foregoing and other exemplary problems, drawbacks, and disadvantages of the conventional methods and structures, an exemplary feature of the present invention is to provide a method and structure in which an Emergency Alert System message is provided in an Internet Protocol.

In a first exemplary aspect of the present invention, a method for providing an Emergency Alert System message in an Internet Protocol includes storing information for an Emergency Alert System message, and creating an Emergency Alert System message in an Internet Protocol format based upon the information.

In a second exemplary aspect of the present invention, a method for presenting an Internet Protocol Emergency Alert System message includes receiving an Internet Protocol Emergency Alert System message, encoding the Internet Protocol Emergency Alert System message, and presenting the encoded Emergency Alert System message.

In a third exemplary aspect of the present invention, a system for providing an Emergency Alert System message in an Internet Protocol includes an Emergency Alert System message storage that stores information for an Emergency Alert System message, and an Emergency Alert System Sender that creates an Emergency Alert System message in an Internet Protocol format based on the information.

In a fourth exemplary aspect of the present invention, a system for presenting an Internet Protocol Emergency Alert System message includes an Emergency Alert System message encoder that receives an Emergency Alert System message in an Internet Protocol and that encodes the Internet Protocol Emergency Alert System message, and an Emergency Alert System message player that plays the encoded Emergency Alert System message.

In a fifth exemplary aspect of the present invention, a system for providing an Emergency Alert System message in an Internet Protocol includes means for storing information for an Emergency Alert System message, and means for creating an Emergency Alert System message in an Internet Protocol format based on the information.

In a sixth exemplary aspect of the present invention, a system for presenting an Internet Protocol Emergency Alert System message includes means for receiving an Internet Protocol Emergency Alert System message, means for decoding the Internet Protocol Emergency Alert System message, and means for presenting the decoded Emergency Alert System message.

In a seventh exemplary aspect of the present invention, a signal-bearing medium tangibly embodying a program of machine-readable instructions executable by a digital processor, the program includes instructions for storing information for an Emergency Alert System message, and instructions for creating an Emergency Alert System message in an Internet Protocol format based upon the information.

In an eighth exemplary aspect of the present invention, a signal-bearing medium tangibly embodying a program of machine-readable instructions executable by a digital processor, the program includes instructions for receiving an Internet Protocol Emergency Alert System message, instructions for decoding the Internet Protocol Emergency Alert System message, and instructions for presenting the decoded Emergency Alert System message.

The inventors of the present invention realize that there is a need for a system that is capable of overcoming the gaps in coverage in the conventional nationwide Emergency Alert System network. An exemplary embodiment of the present invention addresses this need by providing a method and system that allows Emergency Alert System messages to be broadcast over Internet Protocol networks.

An exemplary embodiment of the present invention obviates the need for specialized hardware based encoders and decoders to be distributed throughout the desired coverage area. An exemplary embodiment of the present invention provides the ability to disseminate Emergency Alert System messages across a network using Internet Protocol based networks.

Additionally, an exemplary embodiment of the present invention provides the ability to an originator of an Emergency Alert System message to simultaneously send the Emergency Alert System message to multiple recipients.

For example, an exemplary embodiment of the present invention enables an originator to send an Emergency Alert System message simultaneously to all of the radio and television stations in a desired area for simultaneous and substantially instantaneous broadcast to the public in the desired area.

Further, an exemplary embodiment of the present invention allows an originator to send an Emergency Alert System message across great distances substantially instantaneously, thereby, significantly reducing the amount of time that it takes to deliver the Emergency Alert System message to the desired recipient.

For example, with an exemplary embodiment of the present invention, an originator in Washington, D.C. may place an Emergency Alert System message that is addressed to an IP server located in San Francisco, Calif. That Emergency Alert System message is then delivered directly to the desired IP server and does not suffer the disadvantages of the conventional Emergency Alert System which requires such messages to be relayed by multiple stations that are distributed across the country before that message will reach the desired destination.

Additionally, an exemplary embodiment of the present invention provides an Emergency Alert System that is effective to reach areas that are not currently served by the conventional Emergency Alert System. For example, certain areas of the country have gaps in the airwave coverage and an exemplary embodiment of the present invention may fill those gaps by providing the ability to deliver Emergency Alert System messages to those areas that are not conventionally served.

An exemplary embodiment of the present invention obviates the necessity of specialized encoding/decoding hardware and instead, allows already well-distributed general purpose computers to be programmed with software to perform the functions of encoding, decoding, generating and/or broadcasting of Emergency Alert System messages.

Another exemplary embodiment of the present invention may not only use these programmable computers to perform the functions described above, but may also interface with the conventional specialized encoder and decoder hardware. In this manner, the current airwave Emergency Alert System message delivery system may be supplemented with the present invention and vice-versa.

For example, in accordance with an exemplary embodiment of the present invention, the specialized decoder hardware may be used to receive an Emergency Alert System message from the airwaves and the present invention may then be used to broadcast that message on an IP network.

Similarly, in accordance with yet another exemplary embodiment of the present invention, the present invention may receive an Emergency Alert System message from an IP network and then interface with the conventional specialized encoder hardware to broadcast that Emergency Alert System message on the airwaves.

An exemplary embodiment of the present invention also provides capabilities that are not possible with the conventional Emergency Alert System. An exemplary embodiment of the present invention provides the ability to deliver images and/or video using the Emergency Alert System.

Such an image may be valuable, for example, in an Amber Alert, where a child has gone missing and where it is desirable to quickly distribute a picture of a missing child.

Further, another exemplary embodiment of the present invention, as described above, has the ability to address and simultaneously broadcast an Emergency Alert System message to multiple locations. This feature may also be used in conjunction with the ability, described above, of attaching an image to assist in the recovery of a missing child and/or apprehension of a criminal.

For example, a user may have knowledge and/or suspect that a criminal and/or missing child is travelling across the country on a specific route. For example, a police officer might suspect that a criminal has left the city of Los Angeles and is headed toward New York city in a yellow truck. Further, that police officer may possess a photograph of that yellow truck. With an exemplary embodiment of the present invention, that police officer will be able to generate an Emergency Alert System message that includes the photograph of the yellow truck, and then address that Emergency Alert System message to areas of the country that may be traversed by that criminal while travelling to New York city. In this manner, the police officer is simultaneously able to disseminate the photograph of the yellow truck along with any necessary instructions of what to do if that particular yellow truck is spotted.

Additionally, since an exemplary embodiment of the present invention does not require specialized encoder/decoder hardware, any person possessing a general purpose computer programmed with the present invention will have the capability to receive and display the Emergency Alert System message that is sent by the police officer. For example, truck stops, convenience stores, restaurants, etc. along the suspected route of travel only need to possess a general purpose computer to be able to receive and view the Emergency Alert System message and photograph of the yellow truck.

Similar benefits may be derived with respect to an Emergency Alert System message that includes a photograph of a missing child in accordance with an exemplary embodiment of the present invention.

Further, in an exemplary embodiment of the present invention, not only may a receiver of the Emergency Alert System message have the ability to listen to a voice message and/or display the text accompanying the message, but any receiver will have the ability to locally display and/or print out the data and any accompanying image.

Additionally, in an exemplary embodiment of the present invention, receivers of an Emergency Alert System message may have the ability to query the originator of the message. For example, in an exemplary embodiment of the present invention, an Emergency Alert System message may include a Uniform Resource Locator that indicates a location of a file that includes additional information. That file may include image and/or video data or may include a website that contains any desired amount or organization of information and/or may include information for contacting the originator of the Emergency Alert System message, such as, for example, telephone numbers, names, and/or addresses.

In yet another exemplary embodiment of the present invention, this above-described additional information may be co-hosted by multiple servers thereby increasing the availability and/or bandwidth for such information.

Moreover, an exemplary embodiment of the present invention may also provide the ability to authenticate the veracity and/or source of an Emergency Alert System message. For example, an exemplary embodiment of the present invention may include a method and/or system for digitally signing and/or providing a type of certificate to authenticate the source and/or content of the Emergency Alert System message. In this manner, tampering with the Emergency Alert System message may be inhibited.

These and many other advantages may be achieved with the present invention.

### BRIEF DESCRIPTION OF THE DRAWINGS

The foregoing and other exemplary purposes, aspects and advantages will be better understood from the following detailed description of exemplary embodiments of the invention with reference to the drawings, in which:

FIG. 1 illustrates the conventional Emergency Alert System message protocol 112 as defined by the Federal Communications Commission;

FIG. 2 illustrates a topology in accordance with an exemplary embodiment of an Emergency Alert Message Relay System 200 of the present invention;

FIG. 3 is a block diagram of an exemplary Emergency Alert Relay System 200 in accordance with the present invention;

FIGS. 4A and 4B provide a flowchart illustrating the flow of data within an exemplary embodiment of the Emergency Alert Relay System 200 in accordance with the present invention;

FIG. 5 is a block diagram illustrating a display of an Emergency Alert System message 500 using an exemplary Emergency Alert System Alert Viewer 206 in accordance with the present invention;

FIGS. 6A through 6C show a flowchart that illustrates exemplary Emergency Alert System Message Encoding Algorithm in accordance with the present invention;

FIGS. 7A through 7C illustrate a flowchart for an exemplary Emergency Alert System Message Decoding Algorithm in accordance with the present invention;

FIG. 8 illustrates an exemplary system 800 for incorporating the present invention therein; and

FIG. 9 illustrates an exemplary signal bearing medium 900 (e.g., storage medium) for storing instructions for a method according to the present invention.

### DETAILED DESCRIPTION OF EXEMPLARY EMBODIMENTS OF THE INVENTION

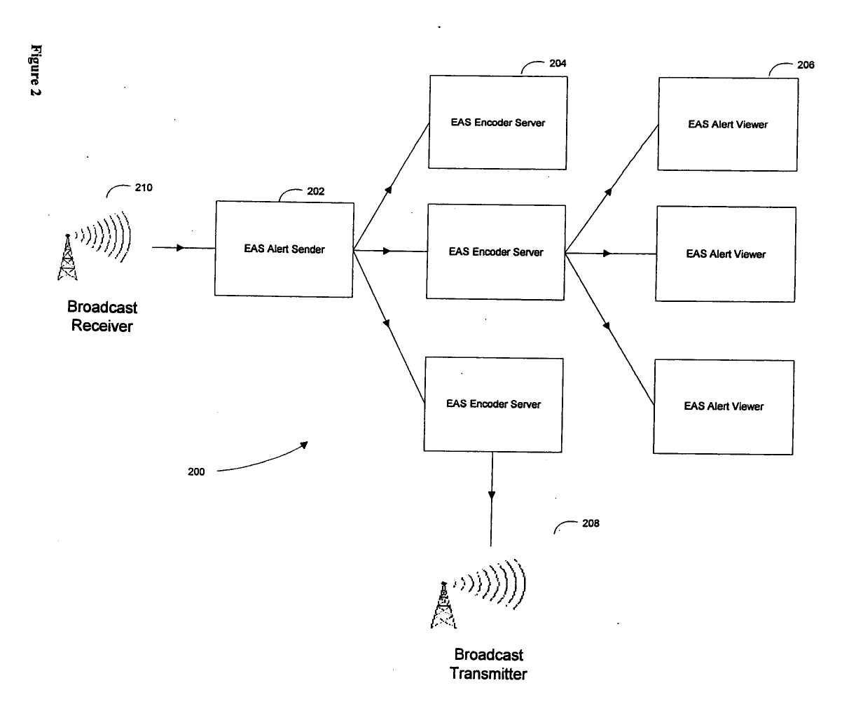

Referring now to the drawings, and more particularly to FIGS. 2-9, there are shown exemplary embodiments of the methods and systems of the present invention.

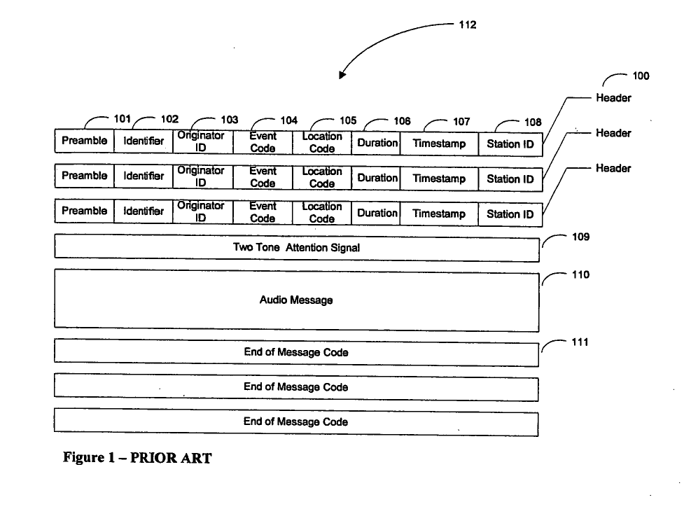

FIG. 1 illustrates the Emergency Alert System message protocol that is defined by the Federal Communications Commission in 47 C.F.R. part 11.31 as follows:
Three audio bursts containing an Audio Frequency Shift Keying encoded header 100. The header includes the following format for a message: [Preamble] ZCZC−ORG−EEE−PSSCCC+TTTT−JJJHHMM−LLLLLLLL.
   The Preamble 101 is a consecutive string of bits (typically, sixteen bytes of AB hexadecimal [8 bit byte 10101011]);
   The character string ZCZC, is an identifier 102 and specifies the start of the header;
   ORG is a three-character originator code 103;
   EEE is a three-character event code 104;
   PSSCCC is a six-character location code 105 based on the FIPS [Federal Information Processing System] codes;
   TTTT is the duration 106 of the event in minutes. For example, “0015” specifies 15 minutes;
   JJHHMM is the timestamp 107 in UTC format; and
   LLLLLLLL is the station identifier 108;
An eight second two-tone attention signal 109 including fundamental frequencies of 853 and 960 Hz that are transmitted simultaneously;
A recorded verbal message 110; and
Three audio bursts containing the Audio Frequency Shift Key encoded End of Message Code 111. The End of Message code includes the following:
   A Preamble; and
   The character string NNNN

Referring to FIG. 2, an exemplary embodiment of an Emergency Alert Relay System 200 in accordance with the present invention may include three modules: an Emergency Alert System Alert Sender 202, an Emergency Alert System Encoder Server 204, and an Emergency Alert System Alert Viewer 206.

The Emergency Alert Relay System 200 may receive audio Emergency Alert System messages from a broadcast receiver 210 and decode an audio Emergency Alert System message using, for example, Audio Frequency Shift Keying (AFSK). The Emergency Alert System Alert Sender 202 may also originate an Emergency Alert System message.

In an exemplary embodiment of the present invention, the Emergency Alert System Alert Sender 202 may be a Java®® software application that may be hosted on any operating system that supports a Java® Virtual Machine.

The Emergency Alert System Alert Sender 202 may broadcast an Emergency Alert System message over an Internet Protocol (IP) network (not shown) to multiple Emergency Alert System Encoder Servers 204.

The Emergency Alert System Encoder Server 204 may receive Emergency Alert System alerts from one or multiple Emergency Alert System Alert Senders 202 via an IP network. The Emergency Alert System Encoder Server 204 may encode the received Emergency Alert System message using Audio Frequency Shift Keying.

The Emergency Alert System Encoder Server 204 may also output an encoded Emergency Alert System message that may be transmitted from a broadcast transmitter 208.

The Emergency Alert System Encoder Server 204 may also forward Emergency Alert System messages to one or multiple Emergency Alert System Alert Viewers 206. The Emergency Alert System Alert Viewer 206 may be a Java® software application that may be hosted on any operating system that supports a Java® Virtual Machine.

The Emergency Alert System Alert Viewer 206 may receive Emergency Alert System messages from one or multiple Emergency Alert System Encoder Servers 204 and display the received Emergency Alert System messages on a screen display (not shown).

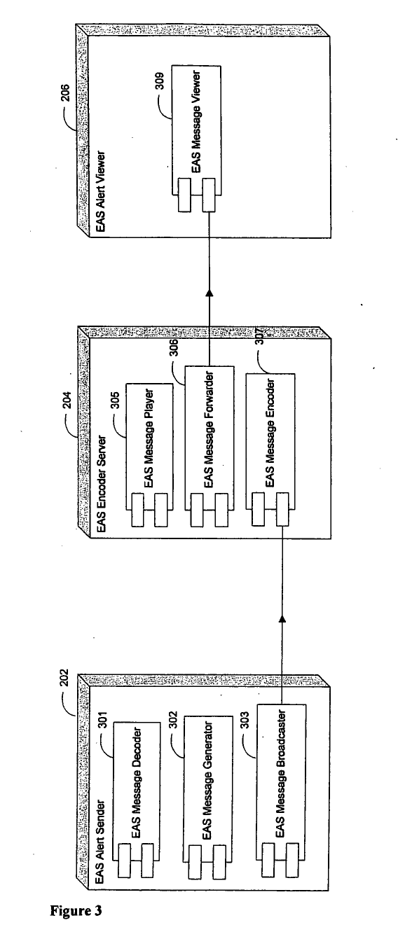

Referring to FIG. 3, an exemplary embodiment of the Emergency Alert System Alert Sender 202 in accordance with the present invention may include various components including an Emergency Alert System Message Decoder 301 that may decode audio Emergency Alert System alert messages received by the Emergency Alert System Alert Sender 202 via a conventional communication channel. Further, an Emergency Alert System Message Generator 302 may generate Emergency Alert System messages, and an Emergency Alert System Message Generator 302 may record a verbal message and specify the Emergency Alert System header information.

In accordance with an exemplary embodiment of the present invention, the Emergency Alert System Message Broadcaster 303 may format the Emergency Alert System message in an IP format and may then broadcast Emergency Alert System messages to one or many Emergency Alert System Encoder Servers 204 over an IP network (not shown).

An exemplary embodiment of the Emergency Alert System Encoder Server 204 may include three components. An Emergency Alert System Message Encoder 307 may encode Emergency Alert System messages using, for example, Audio Frequency Shift Keying. An Emergency Alert System Message Player 305 may output the encoded Emergency Alert System message using, for example, a host computer's line-out. An Emergency Alert System Message Forwarder 306 may forward Emergency Alert System messages to one or multiple Emergency Alert System Alert Viewers 206 over, for example, an IP network (not shown).

An exemplary embodiment of an Emergency Alert System Alert Viewer 206 may include an Emergency Alert System Message Viewer 309 that may display received Emergency Alert System messages on a screen display (not shown).

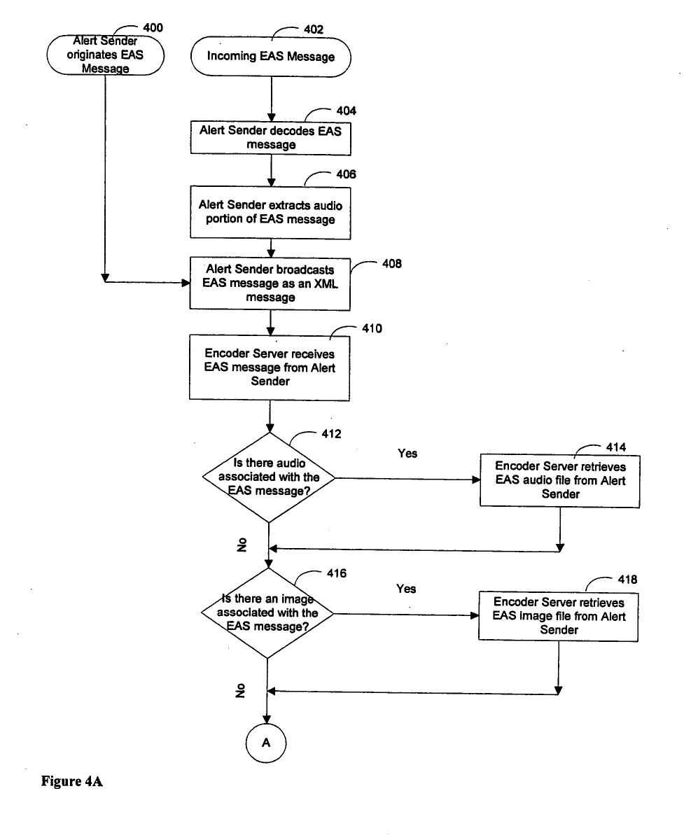

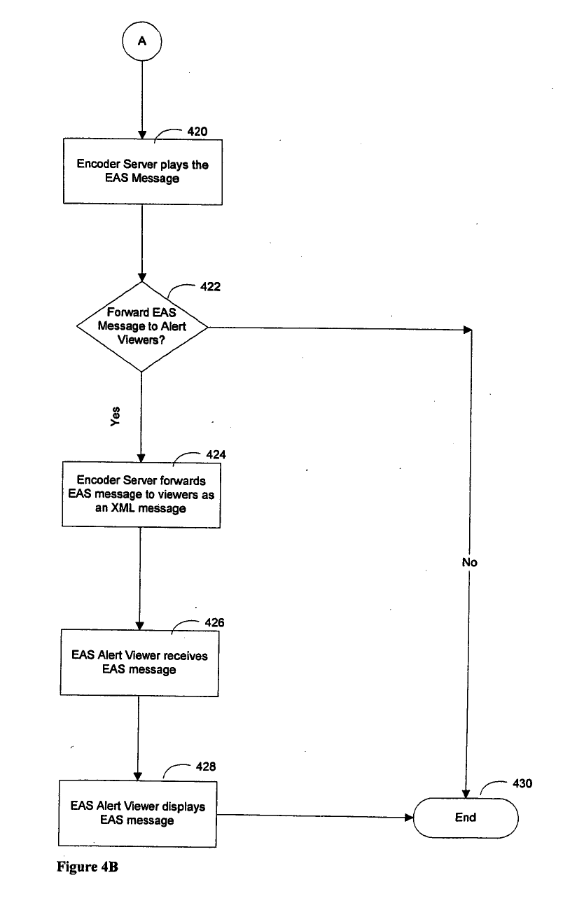

An exemplary Emergency Alert System message flow through an exemplary embodiment of an Emergency Alert System Alert System in accordance with the present invention is illustrated in FIG. 4. The Emergency Alert System Alert Sender 202 may receive an incoming message in step 402 or generate an Emergency Alert System message in step 400.

If, in step 402, the Emergency Alert System Sender 202 receives an incoming message, the flow continues to step 404 and the Emergency Alert System decoder 301 may decode the incoming message. The flow then continues to step 406, where the Emergency Alert System header may be parsed and the verbal message extracted and saved by the Emergency Alert System Message Decoder 301.

Optionally, a message generated by the Emergency Alert System Alert Sender 202 may contain a verbal message as well as an image and/or video associated with the Emergency Alert System message.

Additionally, a decoded message that has been received or a newly generated message may be packaged using an Internet Protocol, such as, for example, an Extensible Markup Language (hereinafter: XML). The XML packaged message may contain the Emergency Alert System message header information representing the associated verbal message and an image and/or video (if any) along with a corresponding Uniform Resource Locator (hereinafter: URL) for the audio and/or video file.

The XML Emergency Alert System message may then be broadcast by the Emergency Alert System Sender 202 to one or many Emergency Alert System Encoder Servers 204 over an IP network in step 408. The Emergency Alert System Encoder Servers 204 may then receive the XML formatted Emergency Alert System message that was broadcast by the Emergency Alert System Alert Sender 302 in step 410.

In step 412, the Emergency Alert System Encoder Server 204 may determine whether an audio file URL is specified in the received XML Emergency Alert System message. If, in step 412, the Emergency Alert System Encoder Server 204 determines that an audio file URL is specified, then flow continues to step 414 where the Emergency Alert System Message Encoder 307 of the Emergency Alert System Encoder Server 304 may retrieve the audio file from the Emergency Alert System Alert Sender 202 using the specified URL and then flow continues to step 416.

The Emergency Alert System Encoder Server 204 may then determine if an image/video file URL is specified in the received XML Emergency Alert System message in step 416. If, in step 416, the Emergency Alert System Encoder Server 204 determines that an image/video file URL is specified, then flow continues to step 418 where the Emergency Alert System Message Encoder 307 of the Emergency Alert System Encoder Server 204 retrieves the image file from the Emergency Alert System Alert Sender 300 using the specified URL and flow then continues to step 420.

If, however, in step 416, the Emergency Alert System Encoder Server 204 determines that an image/video file URL is not specified in the XML Emergency Alert System message, then flow continues to step 420.

In step 420, the Emergency Alert System Message Player 305 of the Emergency Alert System Encoder Server 204 may then play the audio portion of the Emergency Alert System message on, for example, a host computer's line-out (not shown) and flow then continues to step 422.

In step 422, the Emergency Alert System Message Forwarder 306 of the Emergency Alert System Encoder Server 204 determines whether it is configured to forward the Emergency Alert System message to one or multiple Emergency Alert System Alert Viewers 206.

If, in step 422, if the Emergency Alert System Message Forwarder 306 is configured to forward Emergency Alert System messages, then flow continues to step 424. In step 424, the Emergency Alert System Message Forwarder 306 forwards the Emergency Alert System message as an XML Emergency Alert System message to one or multiple Emergency Alert System Alert Viewers 206 and flow continues to step 426.

If, however, in step 422, the Emergency Alert System Message Forwarder 306 is not configured to forward Emergency Alert System messages, then flow continues to step 430 where the flow ceases.

As explained above, the XML Emergency Alert System message forwarded to the Emergency Alert System Alert Viewers 206 may include image/video file URL (if any) embedded within the XML Emergency Alert System message.

In step 426, the Emergency Alert System Alert Viewer 206 may receive the Emergency Alert System message and flow continues to step 428. In step 428, the Emergency Alert System Message Viewer 309 of the Emergency Alert System Alert Viewer 206 may display the Emergency Alert System message on a screen display (not shown) and flow continues to step 430 where flow ceases.

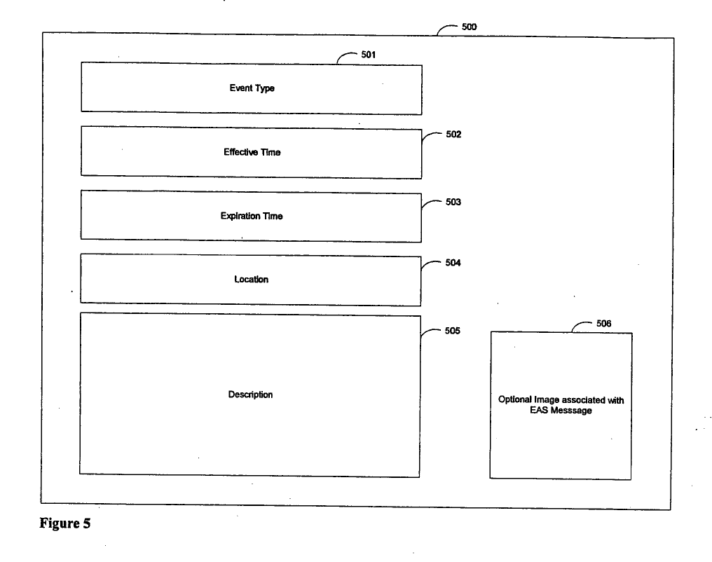

FIG. 5 illustrates an exemplary embodiment of an Emergency Alert System message 500 in accordance with the present invention as may be displayed by an Emergency Alert System Message Viewer 309 of an Emergency Alert System Alert Viewer 206. This exemplary Emergency Alert System message 500 includes an Event Type display area 501, an Effective Time display area 502, an Expiration Time display area 503, a location display area 504, an optional text description display area 505, and an optional image display area 506.

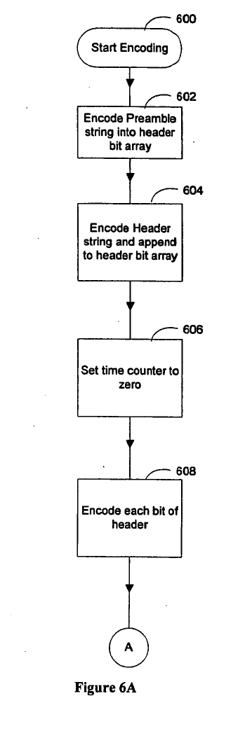

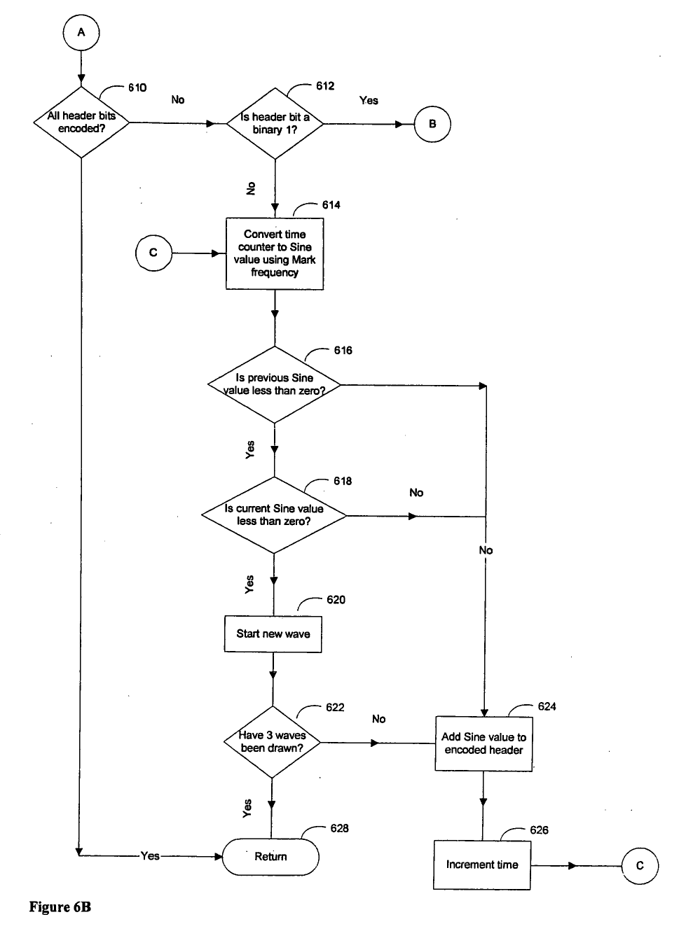

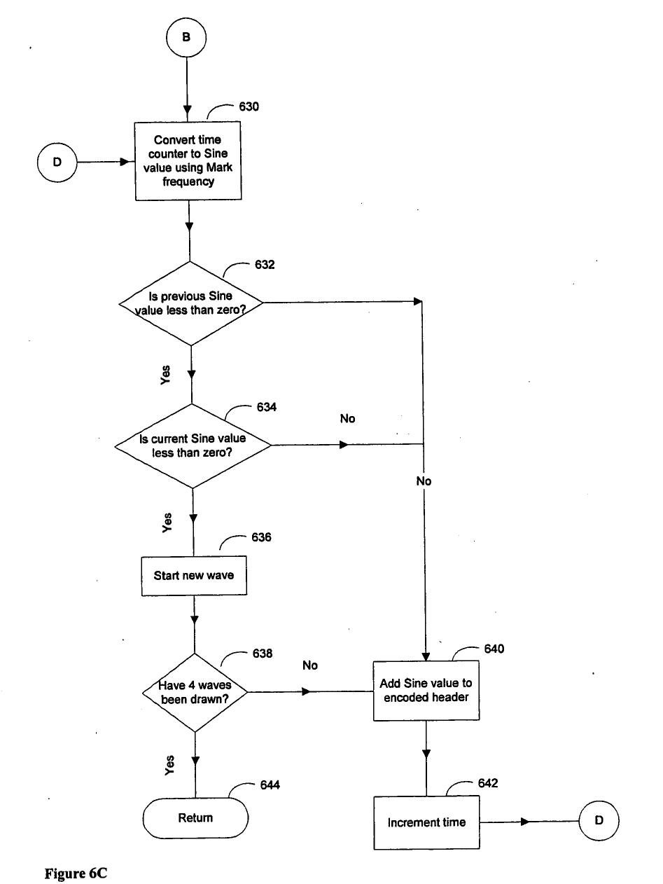

FIGS. 6A through 6C illustrate an exemplary embodiment of an Emergency Alert Message Encoding Algorithm in accordance with the present invention.

This exemplary embodiment of the Emergency Alert Message Encoding Algorithm may use Automatic Frequency Shift Keying. Automatic Frequency Shift Keying is an encoding technique that encodes binary data into audio frequencies by encoding a binary 1 into a MARK frequency and a binary 0 into a SPACE frequency. Automatic Frequency Shift Keying uses a sampling frequency that is a sampling rate for creating the audio stream. A digital audio stream does not include continuous waves of audio, but instead includes points of the wave at specific intervals in time. This interval is a sampling interval. A sampling frequency is selected to create a digital audio stream. So, knowing the sampling frequency and the mark or space frequency allows a Sine curve of the audio wave to be plotted using conventional techniques.

This exemplary embodiment of the Emergency Alert Message Encoding Algorithm may perform Sine calculations to draw a Sine wave in time. Each Sine wave that the Emergency Alert Message Encoding Algorithm calculates may be a y-value in an x-y coordinate space. All of the Sine values taken together constitute an audio wave that may be drawn by plotting the points over time.

This exemplary embodiment of the Emergency Alert System Message Encoding Algorithm creates a point on a Sine wave, saves it and the next point is plotted, after the sampling interval, is compared with the previous value.

An aspect of the exemplary embodiment of the Emergency Alert System Message Encoding Algorithm establishes when a full wave is created to draw and count waves quickly without relying upon oscillators of transforms that are complex algorithms. Rather, the Emergency Alert System Message Encoding Algorithm provides the ability to easily and rapidly determine the presence of a full wave and to draw and count waves using a simple algorithm that may easily adapted to a software implementation.

The Emergency Alert Message Encoding Algorithm starts at step 600 and continues to step 602 where the Emergency Alert Message Encoding Algorithm populates a bit array with sixteen bytes of hexadecimal AB of a Preamble 101. Then, in step 604, the Emergency Alert Message Encoding Algorithm builds and appends a header string to the header bit array. The header string may be, for example, the header string 100 that includes header string portions 102 through 108.

A counter may be used to measure the sampling interval and the Emergency Alert Message Encoding Algorithm initializes the counter to zero in step 606.

Next, in step 608, the Emergency Alert Message Encoding Algorithm encodes each bit of the header bit array representing the header 112 into an audio stream and continues to step 610.

In step 610, the Emergency Alert Message Encoding Algorithm determines whether all header bits have been encoded. If, in step 610, the Emergency Alert Message Encoding Algorithm determines that all header bits have been encoded, then the Emergency Alert Message Encoding Algorithm continues to step 628 and the Emergency Alert Message Encoding Algorithm ceases.

If, however, in step 610, the Emergency Alert Message Encoding Algorithm determines that all header bits have not been encoded, then the Emergency Alert Message Encoding Algorithm continues to step 612.

In step 612, the Emergency Alert Message Encoding Algorithm determines if the next header bit is a binary 1 (i.e., a mark).

If, in step 612, the Emergency Alert Message Encoding Algorithm determines that the next header bit is not a binary 1, then the Emergency Alert Message Encoding Algorithm continues to step 614. In step 614, the Emergency Alert Message Encoding Algorithm computes a Sine value using the space frequency (such as, for example, 1562.5 Hz) and a sampling frequency and the Emergency Alert Message Encoding Algorithm continues to step 616.

In step 616, the Emergency Alert System Message Encoding Algorithm determines whether the previous Sine value is less than zero. The initial previous Sine value may be instantiated to zero.

If, in step 616, the Emergency Alert Message Encoding Algorithm determines that the previous Sine value is less than zero, then the Emergency Alert Message Encoding Algorithm continues to step 618.

In step 618, the Emergency Alert Message Encoding Algorithm determines if the current Sine value is less than zero. If, in step 618, the Emergency Alert Message Encoding Algorithm determines that the current Sine value is less than zero, then the Emergency Alert System Encoding Algorithm continues to step 620.

As explained above, the exemplary Emergency Alert Message Encoding Algorithm may save two values: the previously calculated Sine value and the currently calculated Sine value. The current Sine value may be calculated using the current time value as the Emergency Alert Message Encoding Algorithm processes the header bit array. The two values may be continuously compared to determine if the Emergency Alert Message Encoding Algorithm has drawn full Sine waves.

In step 620, the Emergency Alert Message Encoding Algorithm starts a new wave and continues to step 622. In step 622, the Emergency Alert Message Encoding Algorithm determines whether three waves have been drawn. If, in step 622, the Emergency Alert Message Encoding Algorithm determines that three waves have been drawn, then the Emergency Alert Message Encoding Algorithm continues to step 628.

If, however, in step 622, the Emergency Alert Message Encoding Algorithm determines that the three waves have not been drawn, or, in step 618, the Emergency Alert Message Encoding Algorithm determines that the current Sine value is not less than zero, or, in step 616, the Emergency Alert Message Encoding Algorithm determines that the previous Sine value is not less than zero, then the Emergency Alert Message Encoding Algorithm continues to step 624.

In step 624, the Emergency Alert Message Encoding Algorithm adds the current Sine value to the audio stream and the Emergency Alert message encoding algorithm continues to step 626. In step 626, the Emergency Alert Message Encoding Algorithm increments the interval counter and returns to step 614.

If, however, in step 612, the Emergency Alert Message Encoding Algorithm determines that the next header bit is a binary 1, then the Emergency Alert Message Encoding Algorithm continues to step 630. In step 630, the Emergency Alert Message Encoding Algorithm computes a Sine value using a mark frequency (such as, for example, 2083.3 Hz) and a sampling frequency, then the Emergency Alert Message Encoding Algorithm continues to step 632.

In step 632, the Emergency Alert Message Encoding Algorithm determines whether the previous Sine value is less than zero. If, in step 632, the Emergency Alert Message Encoding Algorithm determines that the previous Sine value is less than zero, then the Emergency Alert Message Encoding Algorithm continues to step 634.

In step 634, the Emergency Alert Message Encoding Algorithm determines whether the current Sine value is less than zero. If, in step 634, the Emergency Alert Message Encoding Algorithm determines that the current Sine value is less than zero then the Emergency Alert message encoding algorithm continues to step 636.

In step 636, the Emergency Alert Message Encoding Algorithm starts a new wave and continues to step 638. In step 638, the Emergency Alert Message Encoding Algorithm determines whether four waves have been drawn. If, in step 638, the Emergency Alert Message Encoding Algorithm determines that four waves have been drawn then the Emergency Alert message encoding algorithm returns to step 644.

If, however, in step 638, the Emergency Alert Message Encoding Algorithm determines that four waves have not been drawn then the Emergency Alert Message Encoding Algorithm continues to step 640.

Similarly, if, however, in step 632, the Emergency Alert Message Encoding Algorithm determines that the previous Sine value is not less than zero, or if, in step 634, the Emergency Alert Message Encoding Algorithm determines that the current Sine value is not less than zero, then the Emergency Alert Message Encoding Algorithm continues to step 640.

In step 640, the Emergency Alert Message Encoding Algorithm adds the current Sine value to the audio stream and the Emergency Alert Message Encoding Algorithm continues to step 642. In step 642, the Emergency Alert Message Encoding Algorithm increments the time and returns to step 630.

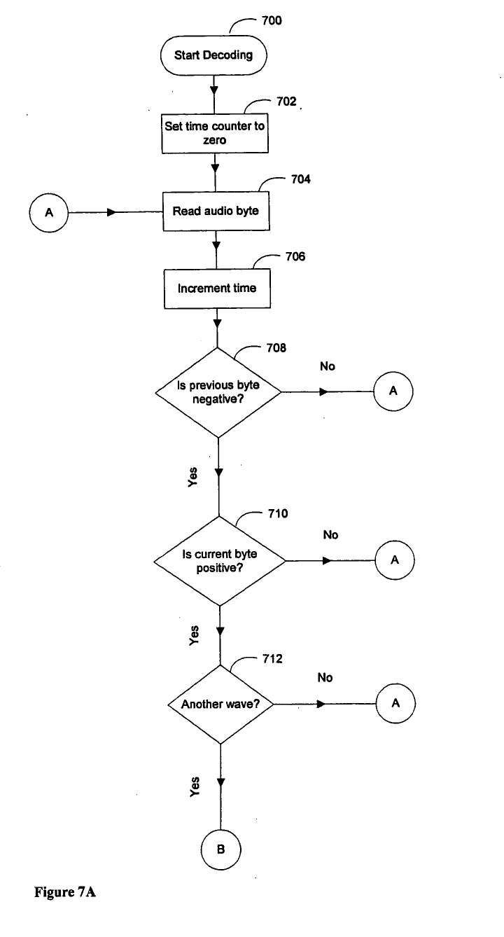

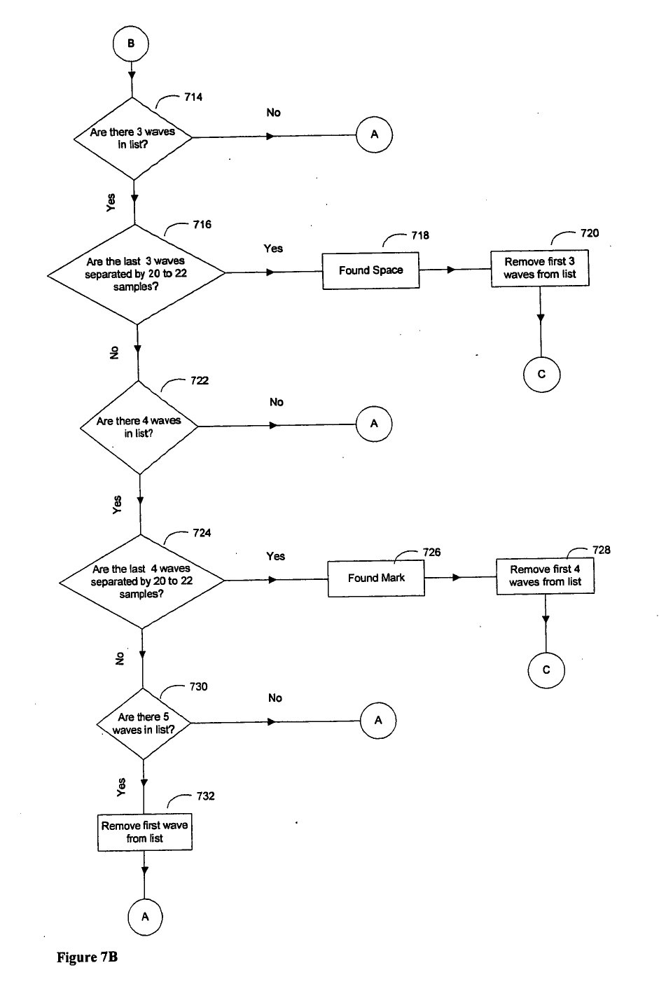

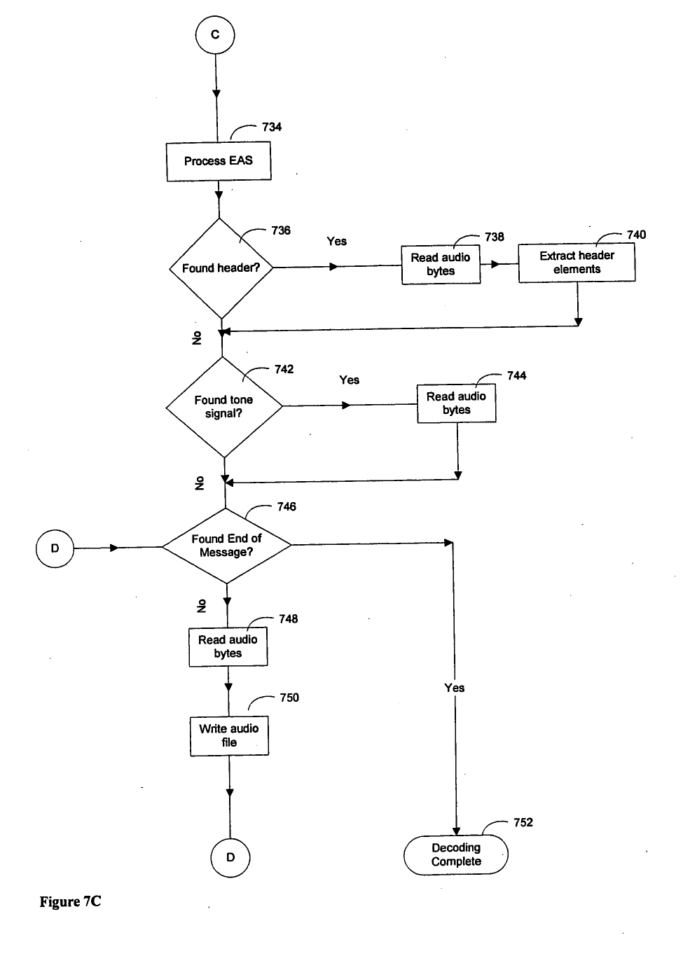

FIGS. 7A through 7C illustrate an exemplary embodiment of an Emergency Alert Message Decoding Algorithm. The Emergency Alert Message Decoding Algorithm starts at step 700 and continues to step 702.

This exemplary embodiment of the Emergency Alert Message Decoding Algorithm maintains a list of waves that have been read. Each time there is a movement between a negative and a positive value between two points in an audio stream, then the Emergency Alert Message Decoding Algorithm determines that a new Sine wave has just been read. The Emergency Alert Message Decoding Algorithm adds the new Sine wave to the list.

Further, this exemplary embodiment of the Emergency Alert Message Decoding Algorithm uses a novel method of counting the waves to decode the AFSK data.

In step 702, the Emergency Alert Message Decoding Algorithm initializes a counter, that may be used to measure the sampling interval, to zero and the Emergency Alert Message Decoding Algorithm continues to step 704.

In step 704, the Emergency Alert Message Decoding Algorithm reads an audio byte from a line-in (not shown) using the Emergency Alert System Message Decoder 301 and the Emergency Alert Message Decoding Algorithm continues to step 706.

In step 706, the Emergency Alert Message Decoding Algorithm increments the timer for the sampling counter and continues to step 708. In step 708, the Emergency Alert Message Decoding Algorithm determines whether the previous byte is negative. The initial previous value may be instantiated to zero. If, in step 708, the Emergency Alert Message Decoding Algorithm determines that the previous byte is not negative, then the Emergency Alert Message Decoding Algorithm returns to step 704.

If, however, in step 708, the Emergency Alert Message Decoding Algorithm determines that the previous byte is negative, then the Emergency Alert Message Decoding Algorithm continues to step 710.

In step 710, the Emergency Alert Message Decoding Algorithm determines whether the current byte is positive. If, in step 710, the Emergency Alert Message Decoding Algorithm determines that the current byte is not positive, then the Emergency Alert Message Decoding Algorithm returns to step 704.

If, however, in step 710, the Emergency Alert Message Decoding Algorithm determines that the current byte is positive, then the Emergency Alert Message Decoding Algorithm continues to step 712.

In step 712, the Emergency Alert Message Decoding Algorithm determines whether there is another wave to add to a list.

If, in step 712, the Emergency Alert Message Decoding Algorithm determines that there is not another wave to add to the list, then the Emergency Alert Message Decoding Algorithm returns to step 704.

If, however, in step 712, the Emergency Alert Message Decoding Algorithm determines that there is another wave to add to the list, then the Emergency Alert Message Decoding Algorithm continues to step 714.

The Emergency Alert Message Decoding Algorithm determines whether the list includes a space frequency or a mark frequency based upon the length. In the exemplary embodiment of the Emergency Alert Message Decoding Algorithm that is described with reference to FIG. 7, the Emergency Alert Message Decoding Algorithm determines whether a space frequency exists when there are three waves and whether a mark frequency exists if there are four waves in the list.

In step 714, the Emergency Alert Message Decoding Algorithm determines whether there are three waves in the list. If, in step 714, the Emergency Alert Message Decoding Algorithm determines that there are not three waves in the list, then the Emergency Alert Message Decoding Algorithm returns to step 704.

If, however, in step 714, the Emergency Alert Message Decoding Algorithm determines that there are three waves in the list, then the Emergency Alert Message Decoding Algorithm continues to step 716.

In step 716, the Emergency Alert Message Decoding Algorithm determines whether the last three waves are separated by a length of time that indicates a space frequency. In the exemplary embodiment of the Emergency Alert Message Decoding Algorithm that is described with reference to FIG. 7, the Emergency Alert Message Decoding Algorithm determines whether the last three waves are separated by twenty to twenty-two samples in order to determine whether the waves include a space. If, in step 716, the Emergency Alert Message Decoding Algorithm determines that the last three waves are separated by twenty to twenty-two samples, then the Emergency Alert Message Decoding Algorithm continues to step 718.

In step 718, the Emergency Alert Message Decoding Algorithm determines that the last three waves constitute a space and continues to step 720. In step 720, the Emergency Alert Message Decoding Algorithm marks a flag to indicate that a space has been found and removes the first three waves from the list and continues to step 734. In step 734, the Emergency Alert Message Decoding Algorithm sets a flag that indicates that a space has been observed.

If, however, in step 716, the Emergency Alert Message Decoding Algorithm determines that the last three waves are not separated by twenty to twenty-two samples, then the Emergency Alert Message Decoding Algorithm continues to step 722.

In step 722, the Emergency Alert Message Decoding Algorithm determines whether four waves are in the list. If, in step 722, the Emergency Alert Message Decoding Algorithm determines that four waves are not in the list, then the Emergency Alert Message Decoding Algorithm returns to step 704.

If, however, in step 722, the Emergency Alert Message Decoding Algorithm determines that four waves are in the list, then the Emergency Alert Message Decoding Algorithm continues to step 724. In step 724, the Emergency Alert Message Decoding Algorithm determines whether the last four waves are separated by twenty to twenty-two samples. In other words, in step 724, the Emergency Alert Message Decoding Algorithm determines whether the four waves constitute a mark.

If, in step 724, the Emergency Alert Message Decoding Algorithm determines that the four waves constitute a mark, then the Emergency Alert Message Decoding Algorithm continues to step 726. In step, 726, the Emergency Alert Message Decoding Algorithm determines that a mark is found, stores a flag to indicate the found mark and continues to step 728 where the Emergency Alert Message Decoding Algorithm removes the first four waves from the list. The Emergency Alert message decoding algorithm then continues to step 734, where, as explained above, the Emergency Alert Message Decoding Algorithm sets a flag indicating that a mark has been observed. From step 734, the Emergency Alert Message Decoding Algorithm continues to step 736.

If, however, in step 724, the Emergency Alert Message Decoding Algorithm determines that the last four waves are not separated (i.e. do not constitute a mark), then the Emergency Alert Message Decoding Algorithm continues to step 730.

In step 730, the Emergency Alert Message Decoding Algorithm determines whether there are five waves in the list. If, in step 730, the Emergency Alert Message Decoding Algorithm determines that there are not five waves in the list, then the Emergency Alert message decoding algorithm returns to step 704.

If, however, in step 730, the Emergency Alert Message Decoding Algorithm determines that five waves are in the list, then the Emergency Alert Message Decoding Algorithm continues to step 732. In step 732, the Emergency Alert Message Decoding Algorithm removes the first wave in the list and the Emergency Alert message decoding algorithm returns to step 704, where, as explained above, the Emergency Alert Message Decoding Algorithm reads another byte from the audio stream.

As will be explained below, this exemplary embodiment of the Emergency Alert Message Decoding Algorithm initially looks for a header (step 736). Once the Emergency Alert Message Decoding Algorithm finds a header, then the Emergency Alert Message Decoding Algorithm looks for a tone (step 742). Once the Emergency Alert Message Decoding Algorithm finds a tone, the Emergency Alert Message Decoding Algorithm looks for an end of message (step 746). While the Emergency Alert Message Decoding Algorithm looks for an end of message, all bytes that are processed by the Emergency Alert Message Decoding Algorithm are stored for the verbal message in the Emergency Alert System message in an audio file.

In other words, the exemplary embodiment of the Emergency Alert Message Decoding Algorithm breaks the Emergency Alert System message down and processes it in parts. The bits of data that are processed mean different things in different portions of the Emergency Alert Message Decoding Algorithm as illustrated by, for example, FIG. 1.

In step 736, the Emergency Alert Message Decoding Algorithm determines whether an Emergency Alert System header is encountered by determining whether a Preamble is found. If, in step 736, the Emergency Alert Message Decoding Algorithm determines that an Emergency Alert System header is encountered, then the Emergency Alert Message Decoding Algorithm continues to step 738.

In step 738, the Emergency Alert Message Decoding Algorithm reads the audio bytes and continues to step 740. In step 740, the Emergency Alert Message Decoding Algorithm extracts the header elements and returns to step 736.

If, however, in step 736, the Emergency Alert Message Decoding Algorithm determines that an Emergency Alert system header is not encountered, then the Emergency Alert Message Decoding Algorithm continues to step 742.

In step 742, the Emergency Alert Message Decoding Algorithm determines whether a two-tone signal is encountered. If, in step 742, the Emergency Alert Message Decoding Algorithm determines that a two-tone signal is encountered, then the Emergency Alert Message Decoding Algorithm continues to step 744. In step 744, the Emergency Alert Message Decoding Algorithm reads audio bytes and returns to step 742. In other words, in step 744, the Emergency Alert Message Decoding Algorithm extracts the verbal portion of the Emergency Alert message.

In step 746, the Emergency Alert Message Decoding Algorithm determines whether an end of message indicator is encountered. If, in step 746, the Emergency Alert Message Decoding Algorithm determines that an end of message indicator is not encountered, then the Emergency Alert message decoding algorithm continues to step 748.

In step 748, the Emergency Alert Message Decoding Algorithm reads the audio bytes and continues to step 750. In step 750, the Emergency Alert Message Decoding Algorithm writes the audio bytes to an audio file and returns to step 746.

If, however, in step 746, the Emergency Alert Message Decoding Algorithm determines that an end of message indicator is encountered, then the Emergency Alert Message Decoding Algorithm continues to step 752. In step 752, the encoding is complete.

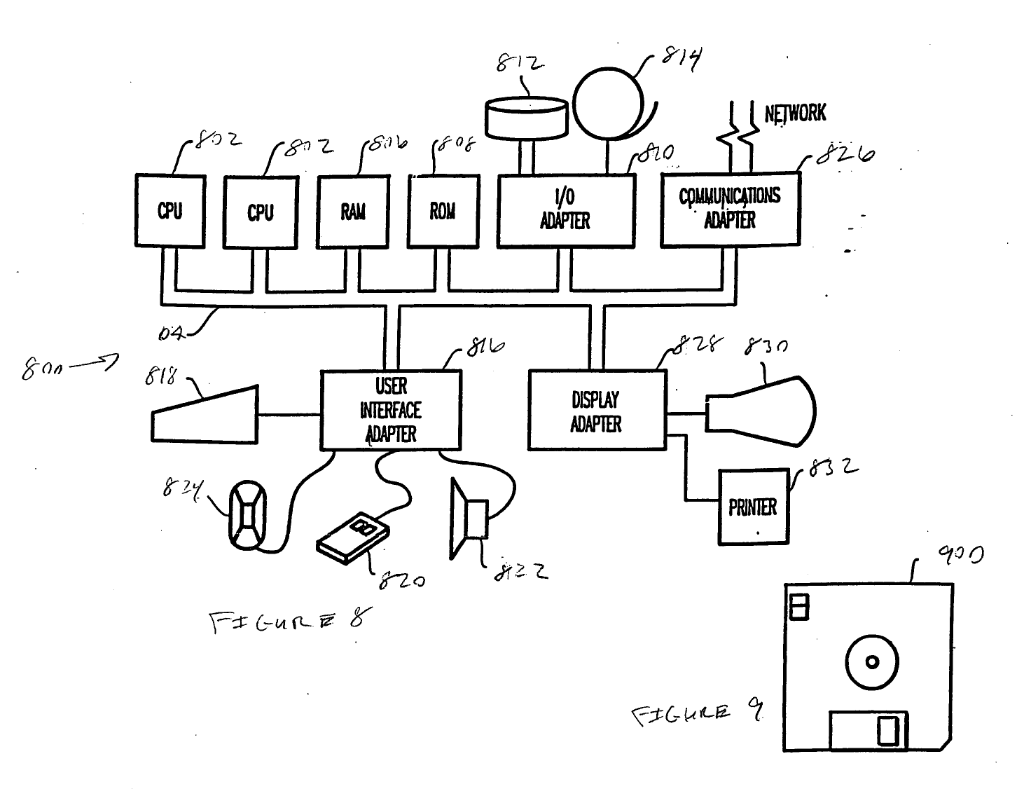

FIG. 8 illustrates a typical hardware configuration of a computer system for use with the invention and which preferably has at least one processor or central processing unit (CPU) 802.

This typical hardware configuration may be used to form any portion of an exemplary embodiment of the Emergency Alert System in accordance with the present invention. For example, the typical hardware configuration of a computer system may be used for any one or all of the Emergency Alert System Alert Sender 202, the Emergency Alert System Encoder Server 204, and/or the Emergency Alert System Alert Viewer 206 in accordance with the present invention.

The CPUs 802 are interconnected via a system bus 804 to a random access memory (RAM) 806, read-only memory (ROM) 808, input/output (I/O) adapter 810 (for connecting peripheral devices such as, for example, disk units 812 and tape drives 814 to the bus 804), user interface adapter 816 (for connecting, for example, a keyboard 818, a mouse 820, a speaker 822, a microphone 824, and/or other user interface device to the bus 804), a communication adapter 826 for connecting to a data processing network, such as, for example, the Internet, an Intranet, a personal area network (PAN), etc., and a display adapter 828 for connecting the bus 804 to a display 830 and/or a printer 832.

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

This signal-bearing media may include, for example, a RAM contained within the CPU 802, as represented by the fast-access storage for example. Alternatively, the instructions may be contained in another signal-bearing media, such as a magnetic data storage diskette 900 (FIG. 9), directly or indirectly accessible by the CPU 802.

Whether contained in the diskette 900, the computer 800, the CPU 802, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, compiled from a language such as “C”, etc.

While the invention has been described in terms of several exemplary embodiments, those skilled in the art will recognize that the invention can be practiced with modification.

Further, it is noted that, Applicants' intent is to encompass equivalents of all claim elements, even if amended later during prosecution.

1. A method for providing an Emergency Alert System message in a network protocol, comprising:
storing information for an Emergency Alert System message; and
creating an Emergency Alert System message in the network protocol format based on the information.

2. The method of claim 1, wherein the network protocol comprises an Internet Protocol.

3. The method of claim 1, wherein the Emergency Alert System message comprises:
three audio bursts;
a two tone attention signal following the three audio bursts;
an audio message following the two tone attention signal;
three more audio bursts following the audio message; and
an image file.

4. The method of claim 3, wherein the Emergency Alert System message further comprises a Uniform Resource Locator for an image file.

5. The method of claim 1, further comprising generating the Emergency Alert System message.

6. The method of claim 1, further comprising transmitting the network protocol Emergency Alert System message.

7. The method of claim 6, wherein the transmitting transmits the network protocol Emergency Alert System message on the Internet.

8. A method for presenting an network protocol Emergency Alert System message, comprising:
receiving Emergency Alert System message in a network protocol;
encoding the network protocol Emergency Alert System message; and
presenting the encoded Emergency Alert System message.

9. The method of claim 8, wherein the network protocol comprises an Internet Protocol.

10. The method of claim 8, wherein presenting the encoded Emergency Alert System message comprises playing the Emergency Alert System message.

11. The method of claim 8, wherein presenting the encoded Emergency Alert System message comprises displaying the decoded Emergency Alert System message.

12. The method of claim 11, wherein the Emergency Alert System message includes an image and wherein presenting the Emergency Alert System message comprises displaying the image.

13. The method of claim 11, wherein the Emergency Alert System message includes a Uniform Resource Locator for an image file and wherein presenting the Emergency Alert System message comprises:
retrieving the image file using the Uniform Resource Locator; and
displaying the image file.

14. A system for providing an Emergency Alert System message in a network protocol, comprising:
an Emergency Alert System message storage that stores information for an Emergency Alert System message; and
an Emergency Alert System Sender that creates an Emergency Alert System message in network protocol format based on the information.

15. The system of claim 14, wherein the network protocol comprises an Internet Protocol.

16. The system of claim 14, wherein the Emergency Alert Sender comprises an Emergency Alert System message broadcaster that transmits the network protocol Emergency Alert System message.

17. The system of claim 14, wherein the Emergency Alert Sender comprises an Emergency Alert System message generator in communication with the Emergency Alert System message storage.

18. The system of claim 17, wherein the Emergency Alert System message comprises:
three audio bursts;
a two tone attention signal following the three audio bursts;
an audio message following the two tone attention signal; and
three more audio bursts following the audio message.

19. The method of claim 18, wherein the Emergency Alert System generator appends an image file to the Emergency Alert System message.

20. The method of claim 18, wherein the Emergency Alert System generator appends a Uniform Resource Locator to the Emergency Alert System message.

21. The system of claim 14, wherein the Emergency Alert Sender comprises an Emergency Alert System message receiver that receives an Emergency Alert System Message.

22. The system of claim 21, wherein the Emergency Alert Sender further comprises a Emergency Alert System message decoder that decodes the received Emergency Alert System message.

23. A system for presenting a network protocol Emergency Alert System message, comprising:
an Emergency Alert System message encoder that receives an Emergency Alert System message in a network protocol and that encodes the network protocol Emergency Alert System message; and
an Emergency Alert System message player that plays the encoded Emergency Alert System message.

24. The system of claim 23, wherein the network protocol comprises an Internet Protocol.

25. The system of claim 23, further comprising an Emergency Alert System message forwarder in communication with the Emergency Alert System message encoder to forward the Emergency Alert System message.

26. The system of claim 23, further comprising an Emergency Alert System message viewer that receives the forwarded Emergency Alert System message from the Emergency Alert System message forwarder and that displays the Emergency Alert System message.

27. A system for providing an Emergency Alert System message in a network protocol, comprising:
means for storing information for an Emergency Alert System message; and
means for creating Emergency Alert System message in a network protocol format based on the information.

28. The system of claim 27, wherein the network protocol comprises an Internet Protocol.

29. A system for presenting a network protocol Emergency Alert System message, comprising:
means for receiving a network protocol Emergency Alert System message;
means for encoding the network protocol Emergency Alert System message; and
means for presenting the encoded Emergency Alert System message.

30. A signal-bearing medium tangibly embodying a program of machine-readable instructions executable by a digital processor, the program comprising:
instructions for storing information for an Emergency Alert System message; and
instructions for creating an Emergency Alert System message in a network protocol format based on the information.

31. A signal-bearing medium tangibly embodying a program of machine-readable instructions executable by a digital processor, the program comprising:
instructions for receiving a network protocol Emergency Alert System message;
instructions for encoding the network protocol Emergency Alert System message; and
instructions for presenting the encoded Emergency Alert System message.
